(19) United States
(12) Patent Application Publication
(10) Pub. No.: US 2026/0277781 A1
(43) Pub. Date: Sep. 17, 2026

(54) COMPLEXITY GENERATOR FOR ENRICHMENT USING MULTI-LEVEL AI GENERATED TEST CASES

(71) Applicant: International Business Machines Corporation, Armonk, NY (US)

(72) Inventor: Mikael Hillborg, Umeå (SE)

(21) Appl. No.: 19/188,303

(22) Filed: Apr. 24, 2025

(30) Foreign Application Priority Data
Mar. 11, 2025 (GB) 2503533.8

(51) Int. Cl. G06F 11/3668

(52) U.S. Cl. CPC G06F 11/3692; G06F 11/3684; G06F 11/3688

(57) ABSTRACT

A method, system, computer program product and computer program for enhancing an external artificial intelligence, AI, system, comprising: receiving at least one test case, the at least one test case comprising a set of objects; providing, using a generative AI model, a set of modifications to the at least one test case to generate a set of alternative test cases, each of the set of modifications comprising a respective complexity level; challenging the external AI with the set of alternative test cases to determine a result from running the set of alternative test cases on the external AI system; and comparing the respective result with a baseline to determine if the respective complexity level causes a problem in the external AI system.

### TECHNICAL FIELD

The invention is generally directed to artificial intelligence systems. In particular it provides a method, system, computer program product and a computer program for an iterative multimodal AI validation and enhancement system based on challenges generated with AI from test cases.

### BACKGROUND ART

Generative AI is a type of artificial intelligence that can create original content, such as text, images, audio, video, code etc., in response to user prompts or requests. Generative AI uses neural network models which may have a variety of topologies. These models work by identifying and encoding the patterns and relationships in huge amounts of data. One example of generative AI is ChatGPT. Another example is Perplexity, which uses a search engine with generative AI technology.

In general generative AI operates in three phases:
Training, to create a model that can serve as the basis of multiple generative AI applications.
Tuning, to tailor the foundation model to a specific generative AI application.
Generation, evaluation and retuning, to assess the generative AI application's output and continually improve its quality and accuracy.

Data-based generative AI refers to artificial intelligence models that are trained on large datasets to generate new content or data that is similar to the training data. These models learn patterns and structures from the input data, allowing them to create novel outputs across various domains.

A language model is an example of generative AI, which have shown significant potential for rule extraction and learning tasks, offering several advantages in this domain. Language models don't need to be very large to be efficient. Another example of a language model is Large Language Model (LLM). LLMs can be leveraged for rule extraction in various ways. LLMs analyze vast amounts of text data to identify recurring patterns that can be translated into rules. This allows LLMs to extract implicit rules from unstructured data. Once rules are established, LLMs can generate inferences that align with these rules, improving their accuracy in tasks such as question answering and summarization. LLMs can assist in generating initial sets of logic rules for systems. Optionally, these initial sets can then be reviewed and refined, for example, by subject matter experts. LLMs are trained to predict the most probable next word according to training examples. For this purpose, the LLM computes a probability for each candidate word. A sampling procedure then randomly chooses one of the words according to these probabilities. A sequence of words is determined by repeating this procedure several times.

Enterprise leaders may feel unsecure with generative AI, because they don't know if the application might generate problematic results for the enterprise even for input data that would seem normal from an LLM's point of view. An example is a contract. An LLM can generate a sample contract, for example as a guide or example for attorneys based on the probability of features. However, problems arise to an enterprise if a user uses directed prompts to elicit a binding agreement through interfacing to a chatbot, for example, as used to try to secure a $1 Chevy Tahoe.

Multimodal AI are systems capable of processing and integrating multiple types of data inputs simultaneously, for example, text, images, audio and video signals. An example of use is in the automotive industry, using multimodal AI in enhancing Advanced Driver Assistance System: traffic sign recognition modules read and interpret traffic signs, displaying information on the dashboard. Another example is in e-commerce, where multimodal AI is used in inventory management.

Examples of multimodal AI include GPT-4 (OpenAI), Claude 3 (Anthropic), DALL-E 3 (OpenAI), and LLaVA (Large Language and Vision Assistant).

There's a need for a platform which allows for testing the performance of any AI platform and any modality, by discovering potential problems in even corporately approved ordinary test cases. Another unknown is the sensitivity of such test cases to incremental parameter variations.

Therefore, there is a need in the art to address the aforementioned problem.

### SUMMARY OF INVENTION

According to the present invention there are provided a method, a system, a computer program product, and a computer program according to the independent claims.

Viewed from a first aspect, the present invention provides a computer implemented method for enhancing an external artificial intelligence, AI, system, the method comprising: A computer implemented method for enhancing an external artificial intelligence, AI, system, the method comprising: receiving at least one test case, the at least one test case comprising a set of objects; providing, using a generative AI model, a set of modifications to the at least one test case to generate a set of alternative test cases, each of the set of modifications comprising a respective complexity level; challenging the external AI with the set of alternative test cases to determine a result from running the set of alternative test cases on the external AI system; and comparing the respective result with a baseline to determine if the respective complexity level causes a problem in the external AI system.

Viewed from a further aspect, the present invention provides a system for enhancing an external artificial intelligence, AI, system, the system comprising: the system comprising: an api for receiving at least one test case, the at least one test case comprising a set of objects; a case generator for providing, using a generative AI model, a set of modifications to the at least one test case to generate a set of alternative test cases, each of the set of modifications comprising a respective complexity level; a router for challenging the external AI with the set of alternative test cases to determine a result from running the set of alternative test cases on the external AI system; and an analyser for comparing the respective result with a baseline to determine if the respective complexity level.

Viewed from a further aspect, the present invention provides a computer program product for enhancing an external artificial intelligence, AI, system, the computer program product comprising: a computer readable storage medium readable by a processing circuit and storing instructions for execution by the processing circuit for performing a method of the invention.

Viewed from a further aspect, the present invention provides a computer program stored on a computer readable medium and loadable into the internal memory of a digital computer, comprising software code portions for performing the steps of the invention, when said program is run on a computer.

Preferably, the present invention provides a method, system, computer program product and computer program, wherein the set of objects comprises a set of multimodal objects, the method further comprising: identifying one or more modalities of each of the objects; wherein providing comprises, for at least one of the objects, for each of the identified modalities, using a respective generative AI model for modifying at least one object of the respective modality; and fusing the set of modified objects to provide the at least one alternative test case.

Preferably, the present invention provides a method, system, computer program product and computer program, wherein providing a set of modifications is performed iteratively, each iteration comprising a respective complexity level.

Preferably, the present invention provides a method, system, computer program product and computer program, wherein respective complexity levels follow a complexity profile between iterations.

Preferably, the present invention provides a method, system, computer program product and computer program, wherein the complexity profile is taken from a group, the group comprising the complexity profile: increasing fast for each iteration; increasing uniformly for each iteration; increasing slowly for each iteration; and constant for each iteration.

Preferably, the present invention provides a method, system, computer program product and computer program, wherein the set of alternative test cases comprises a first portion comprising a first set of alternative tests cases from a first iteration, and a second weighted portion comprising a second set of alternative test cases from a second iteration.

Preferably, the present invention provides a method, system, computer program product and computer program, wherein a number of iterations is determined for complexity levels between a start complexity level and a maximum complexity level.

Preferably, the present invention provides a method, system, computer program product and computer program, wherein the at least one test case comprises one of a list, the list comprising: an image; audio; text; a prompt, and binary data, and wherein generating comprises selecting a feature, modifying the feature, and adding the modified feature to the at least one test case to provide the at least one alternative test case.

Preferably, the present invention provides a method, system, computer program product and computer program, further comprising: in response to determining a problem in the external AI system, sending information about the set of alternative test cases to the external AI system.

Preferably, the present invention provides a method, system, computer program product and computer program, wherein a parameter defines which type of modifications the system is allowed to perform.

Preferably, the present invention provides a method, system, computer program product and computer program, further comprising receiving a user defined distance function, and wherein comparing the respective result comprises using the distance function.

Advantageously, the invention allows a user to configure a complexity level of iterative tests which are generated on multi-modal data, by controlling which types of operations are allowed for each modality with the possibility to configure a well-defined progression complexity profile, which describes how each iteration of tests will result in an increase of complexity level, with a windowing/tail function that ensures that prior complexity levels are included in future ones. The purpose is to test which complexity level results in too many failures and which combinations of properties that cause the failures, locating the lowest complexity level which results in an unacceptable number of failures, where a failure is defined as a result which is different than the source which the challenge was created from. The invention works in the context of a system which features an iterative mechanism that uses multimodal generative AI to challenge any external AI system, using test cases provided by the user.

The current invention relates to a first system comprising an API that can be connected to a second system to iterate by supplying a set of multimodal test cases with or without features, which in each iteration brings AI generated variations of rising complexity level of the test cases back according to a user defined complexity profile where the complexity profile has a base complexity level, a user defined shape and test case related properties, to measure exactly which weaknesses of the second system.

Advantageously, a complexity generator enriches the data with more complex cases which are based on original reviewed cases, but the cases which are created aim to provoke errors, so the enterprise can trace on which level the errors occur. The complexity generator ensures that test cases are created in a way which fits the enterprise that is using the system. Encodings of data can be controlled in the sense that if the organization knows that there will always be one and only one certain encoding of the data, then the system won't try other encodings of the data. The complexity level can be configured to manage location. For example, if the test cases cover a certain indoor location, a certain outdoor location, both or if it's irrelevant, then relevant cases will be generated accordingly, regardless of modality (e.g. text, audio or images). Tests are iterative in the sense that in the first iteration there's a complexity level that can be started from. In many cases that will be a low complexity level in which the most basic flaws will be revealed and as the tester moves on with additional tests, the complexity generator increases complexity in a way which can be configured by the user. There is also function that makes sure that it's not possible to move from a low complexity level to a higher, without solving problems which have a lower complexity.

Advantageously, any external AI system can be connected through an API to supply a data set of ordinary test cases), which are analyzed and converted into a set of challenge items. The challenge items are created by computing a granularity of changes, a specific complexity level (depending on which iteration is carried out, if more than 1), with user defined settings, through the invocation of a multimodal case generation that uses properties which are obtained from a modality property store. The invention makes it possible to determine the level of modification to benign data that is needed to provoke an error to the external AI system. This also allows an assessment of whether a potential weakness is associated with a particular modality, e.g. text or images, or audio etc. As a result, steps can be taken to improve the external AI system to improve its robustness.

Advantageously, the system allows an enterprise to examine whether vulnerabilities are isolated to a particular modality or not (for example, prompts are vulnerable, but image analytics and speech-to-text is not).

Advantageously, the system iterates to create a set of challenges which constitutes a sequence of increasing complexity level, where each iteration makes an incremental change of the challenge in terms of various properties the challenge has. This is performed with or without features that have been selected (manually or automatically). The system provides (a) a combinatorial analysis, (b) statistical analysis and (c) feature/non-feature analyses of weaknesses on all complexity levels.

Advantageously, different modalities can be handled in parallel, and then compared to decide which modality needs to be improved. The system allows for testing of all modalities with respect to a certain complexity level. In practice, the device tests all modalities in parallel for a certain complexity level. At one complexity level results may be satisfactory, but then as complexity increases, one modality may be identified as not responding as expected.

Advantageously, the system tests an external AI application. This might involve any type of underlying AI infrastructure, such as a foundation model or any type of AI. That can also reveal that the training set that was used to build the external AI system was insufficient. The system can then supply more training cases to cover up for the lack of cases.

As an example, the system may be integrated with an external AI system that is a chatbot which answers questions about a set of products. The system generates data that represents a huge amount of variations in how these questions might be asked, including cultural variations, variations due to illness, lack of language skills, attitude, mood etc. The external AI should be able to answer the questions. However, if the external AI was not trained on the correct training data, answers may be incorrect for the real world.

Advantageously, the system can be used to measure a large variety of external AI systems, since the system uses a variety of distance functions to measure whether it was the “same result” (or not), and since it supports multiple modalities.

Advantageously, the system integrates with an external AI system, ingests data that is relevant for the external AI system (for example a handful of free-text survey responses as in the first case above). The system uses generative AI to modify these responses to provide a much richer set of responses and sends all the generated cases to the external AI system and checks the result by comparing it with the result of the source text.

Advantageously, for all modalities the system takes an input document (test case) supplied by the user and generates any number of variations. Each variation is compared with the original document using a distance function. For documents containing images, the actual scene might be modified using generative AI. For example objects might be removed, changed or replaced. Or various transformations of the image properties might be carried out, such as adding noise or changing lightning conditions etc. The system can either be configured to modify features only, never modify features or sometimes (for some variations) modify features.

### BRIEF DESCRIPTION OF THE DRAWINGS

The present invention will now be described, by way of example only, with reference to preferred embodiments, as illustrated in the following figures:

FIG. 1 depicts a computing environment, according to an embodiment of the present invention;

FIG. 2 depicts a high-level exemplary schematic flow diagram depicting operation methods steps for an iterative multimodal AI validation and enhancement system based on challenges generated with AI from test cases, according to a preferred embodiment of the present invention;

FIG. 3, depicts a high-level diagram depicting components of an external AI system and a system 201, according to a preferred embodiment of the present invention;

FIG. 4 depicts an example test case, according to a preferred embodiment of the present invention;

FIG. 5 depicts alternative test cases, according to a preferred embodiment of the present invention;

FIG. 6 depicts a complexity graph, according to a preferred embodiment of the present invention;

FIG. 7 also depicts a complexity graph for multiple modes, according to a preferred embodiment of the present invention; and

FIG. 8 depicts a filtered tail, according to a preferred embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

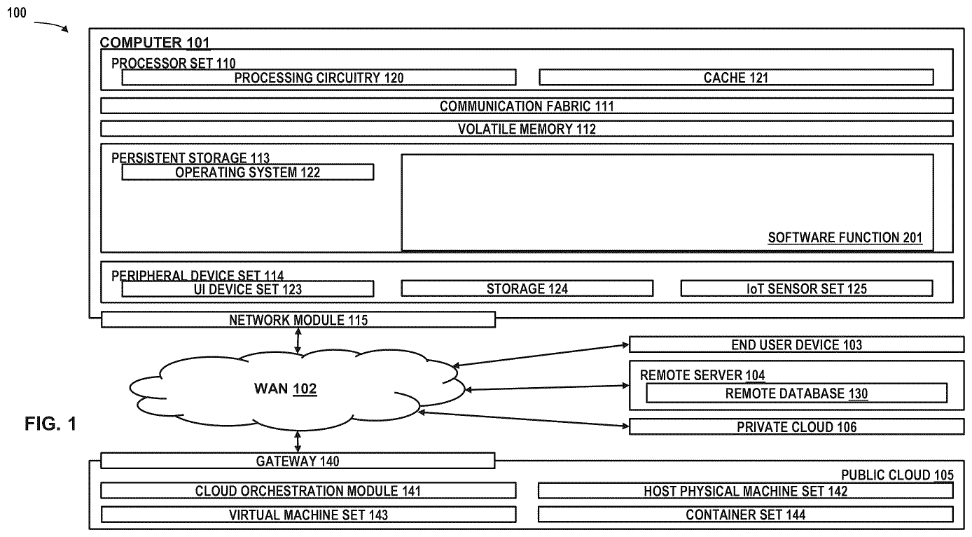

FIG. 1 depicts a computing environment 100. Computing environment 100 contains an example of an environment for the execution of at least some of the computer code involved in performing the inventive methods, such as software functionality 201 for improved rule extraction. In addition to block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard disk, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above invention may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

Moreover, the same or similar reference numbers are used throughout the drawings to denote the same or similar features, elements, or structures, and thus, a detailed explanation of the same or similar features, elements, or structures will not be repeated for each of the drawings. The terms “about” or “substantially” as used herein with regard to thicknesses, widths, percentages, ranges, etc., are meant to denote being close or approximate to, but not exactly. For example, the term “about” or “substantially” as used herein implies that a small margin of error is present. Further, the terms “vertical” or “vertical direction” or “vertical height” as used herein denote a Z-direction of the Cartesian coordinates shown in the drawings, and the terms “horizontal,” or “horizontal direction,” or “lateral direction” as used herein denote an X-direction and/or Y-direction of the Cartesian coordinates shown in the drawings.

Additionally, the term “illustrative” is used herein to mean “serving as an example, instance or illustration.” Any embodiment or design described herein is intended to be “illustrative” and is not necessarily to be construed as preferred or advantageous over other embodiments or designs.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

For the avoidance of doubt, the term “comprising”, as used herein throughout the description and claims is not to be construed as meaning “consisting only of”.

A ‘prompt’ in the context of LLMs is a natural language input provided to the model to elicit a desired response or perform a specific task. A prompt is natural language text describing the task that an AI should perform. It can be a query, command, statement, or longer text including context and instructions. Prompts guide the LLM to generate appropriate outputs. They provide the model with the information needed to produce accurate, relevant responses. Prompts can be questions, commands, or context rich statements. Prompts may also be multimodal.

Convolutional neural networks (CNNs) use convolutional layers with filters and pooling layers to extract features from input data. Recurrent neural networks (RNNs) have a recurrent structure with loops that allow information to persist, enabling them to process sequences of varying lengths.

A multimodal deep learning model is suitable for analyzing data that includes image, text, and sound etc. Typically, prior art multimodal deep learning models typically consist of:
a. Unimodal encoders separate neural networks specialized for each input modality (image, text, and sound).
   i. Image recognition can be made using CNNs by recognizing patterns that make up image features.
   ii. RNNs or transformer-based models are useful for text.
   iii. Sound recognition can be made using spectral analysis, processed by RNNs, including Long Short-Term Memory (LSTM) networks, or CNNs depending on the specific audio processing task.
b. A fusion network combines the features extracted from each input modality. Multimodal AI uses fusion to integrate disparate data types. Fusion of data can be made at different stages of the process. In ‘Early Fusion’ data is mixed at the start. In ‘Intermediate Fusion’ data is processed separately, fused, and then processed. In ‘Late Fusion’ data is combined at the end of the process. ‘Hybrid Fusion’ uses a combination of the fusion techniques.
c. A classifier accepts the fused data and makes predictions based on the combined information from all modalities.

The “training” cases of an AI model are not the same as its “test” cases (also known as “use” cases). These are distinct datasets used for different purposes in the development and evaluation of AI models.

Training case data is used to teach the AI model patterns and relationships. The model learns directly from this data to adjust its parameters and improve its performance. Training case data is used for learning. Test data, on the other hand, is a separate dataset used to evaluate the model's performance after training is complete. This data is completely new to the model and serves as a final, real-world check to confirm that the AI algorithm was trained effectively. Test case data is for evaluation.

An AI system is customized to meet a specific scenario or application where artificial intelligence can be used to solve a business problem or improve a process. In contrast, “training cases” are part of the data used to train AI models, which is a step in developing AI solutions for the specific scenario.

Generative AI can create suitable test cases for another AI system through a multi-step process that leverages machine learning techniques and domain-specific knowledge.

The following are typical steps:
a. Data Collection and Analysis: The generative AI first gathers and analyzes relevant data, including existing test cases, software requirements, scenarios and specifications related to the target AI system. Using natural language processing, the AI interprets the requirements and specifications of the target system to understand its purpose and functionality. The generative AI identifies common testing patterns and applies them to the specific context of the target AI system.
b. Test Case Generation is based on the analyzed data and understood context, the AI generates a diverse set of test cases that cover various scenarios, including edge cases.
c. Optimization for AI training is made by tailoring the generated test case specifically for training the other AI system by ensuring a wide range of input variations to improve the target AI's generalization capabilities, including edge cases and unusual scenarios to enhance the target AI's robustness, and generating synthetic data that mimics real-world scenarios the target AI might encounter.

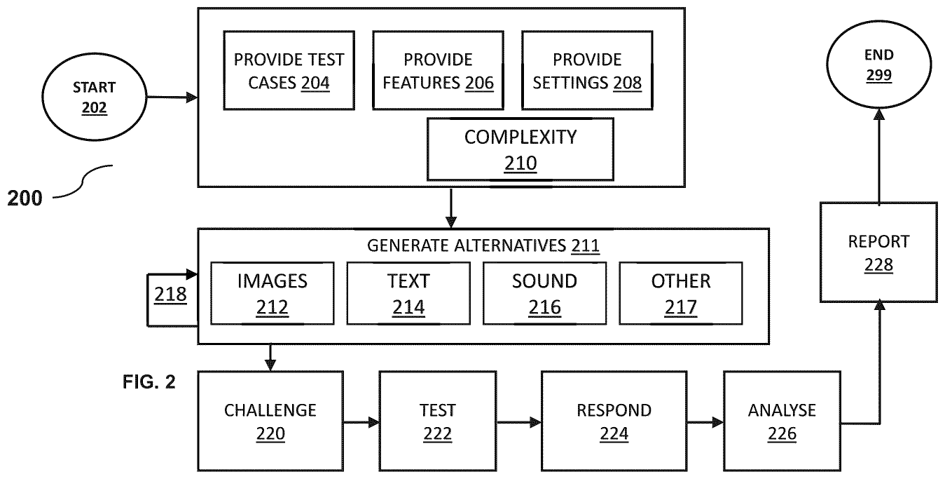

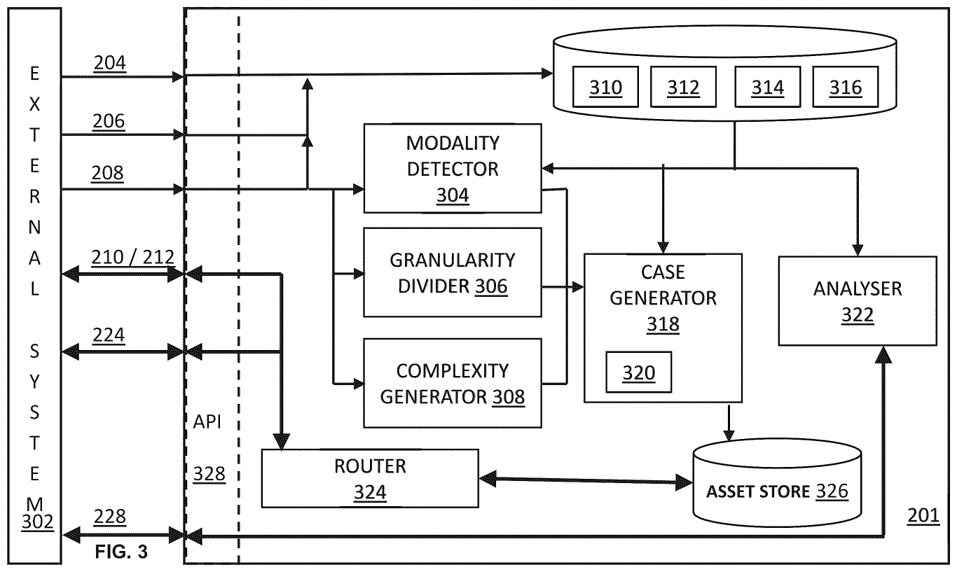

FIG. 2, which should be read in conjunction with FIGS. 3-8, depicts a high-level exemplary schematic flow diagram 200 depicting operation methods steps for an iterative multimodal AI validation and enhancement system based on challenges generated with AI from test cases, according to a preferred embodiment of the present invention.

FIG. 3, depicts a high-level diagram 300 depicting components of an external AI system 302 and a system 201, according to a preferred embodiment of the present invention.

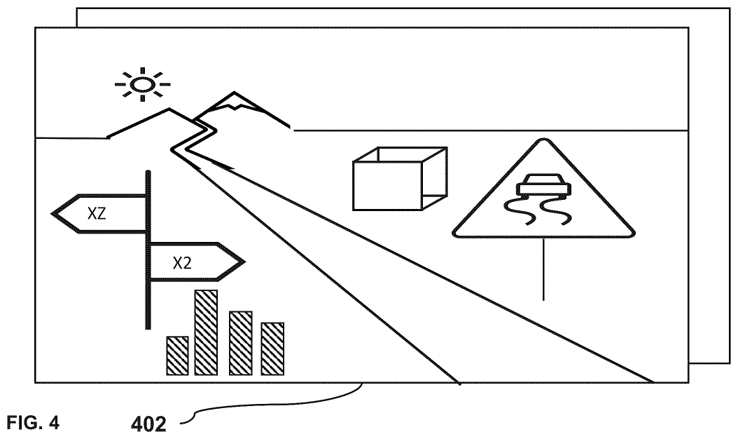

FIG. 4 depicts an example test case 402, according to a preferred embodiment of the present invention.

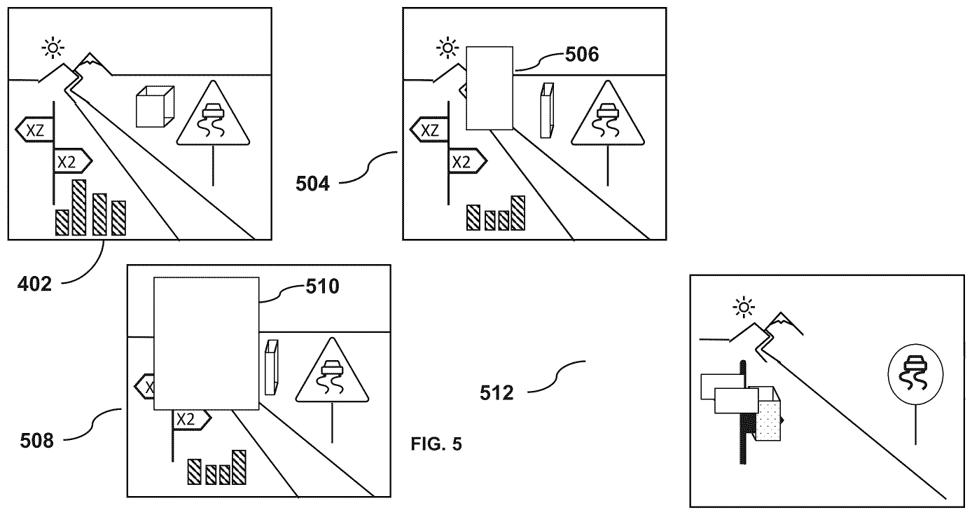

FIG. 5 depicts alternative test cases, according to a preferred embodiment of the present invention. This test case is used to illustrate the invention. Using an example of a vehicle with AI assistance, test case 402 depicts a typical scene. The purpose of the test is to determine the performance of the AI assistance model with route finding. This example is to aid understanding of the invention. The skilled person would understand that the invention can be applied to solve numerous technical problems.

The test case 402 depicts a landscape comprising a sign post 404, a road sign 410, a 3D object 408, and bends in the road through a mountain pass 412. The test case 402 also provides voice instructions depicted in the figure by sound output 406. The task may be, for example, directing the driver, or autonomous vehicle to “XZ”, which is to be found after bends in a road through a mountain pass 412.

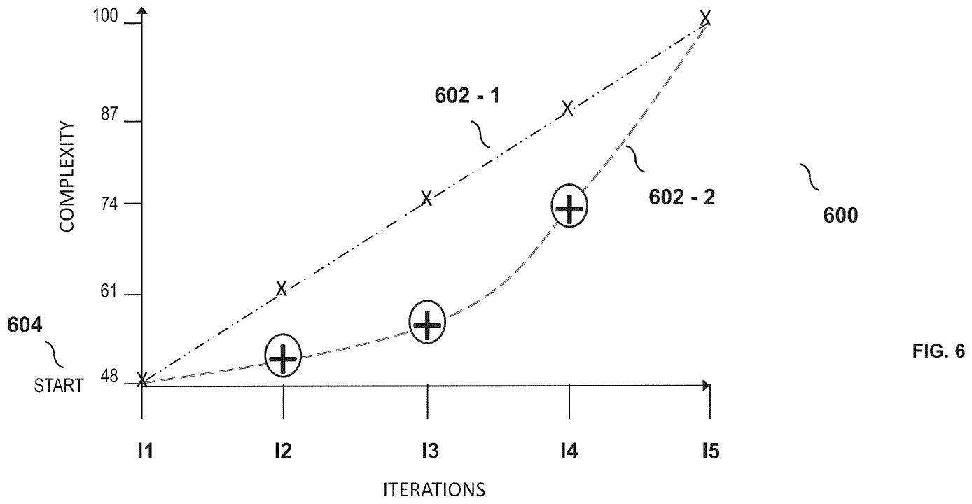

FIG. 6 depicts a complexity graph 600, according to a preferred embodiment of the present invention.

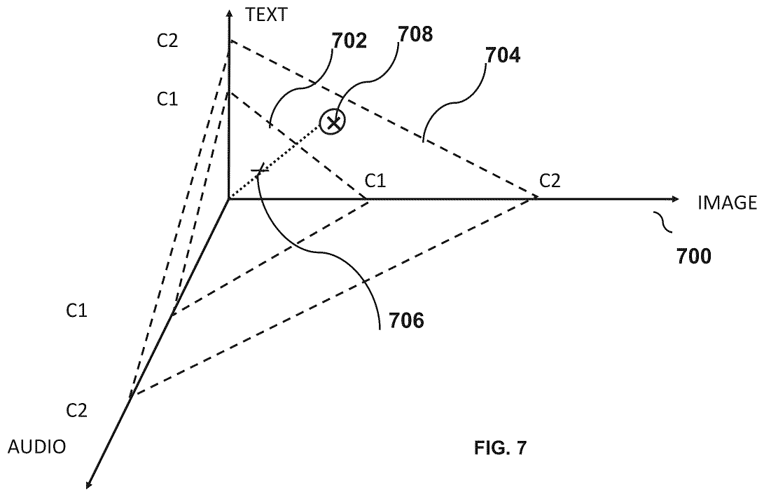

FIG. 7 also depicts a complexity graph 700 for multiple modes, according to a preferred embodiment of the present invention.

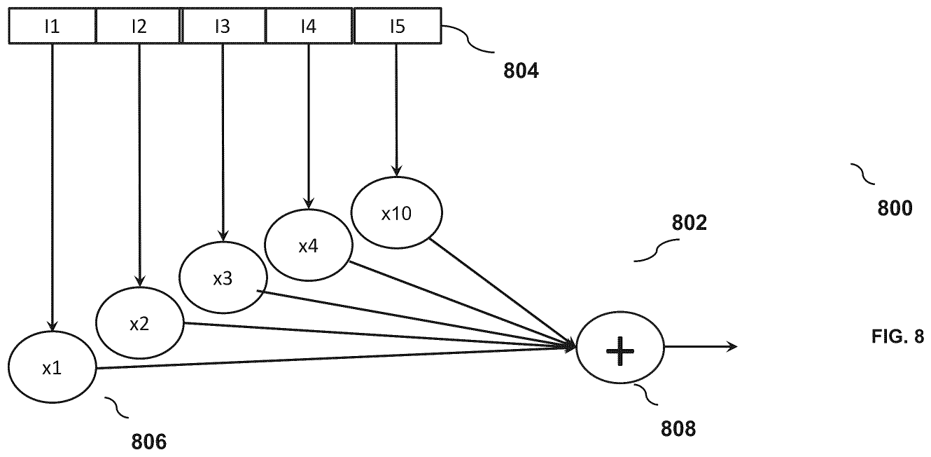

FIG. 8 depicts a filtered tail 800, according to a preferred embodiment of the present invention.

In each step when the user obtains a challenge for a particular document, a router 324 routes it to an AI asset which is stored in an AI asset store 326, for that specific document. The AI asset represents a challenge for that specific document with respect to settings, complexity level, the shape of the complexity (dependent on which iteration is carried out, complexity can increase fast or not), and which modality it has. Complexity determines how the generated document should be modified (a minor change or comprehensive). Complexity is used when the challenge is created. Complexity acts as a measure of modification. So a relatively small set of feature changes applied to the original test case can be considered as having a low complexity level, and a relatively large set of feature changes can be considered as having a higher complexity level. The complexity level represent a level of feature changes made to the corresponding test case. The complexity level can be multidimensional, in that the features changes, can include changes in object size, shape, or the amount of noise added to the test case, etc.

The method starts at step 202.

At step 204 a set of multimodal test cases 402 are provided to software functionality of the system 201 (hereinto described as the system 201) from the external AI system 302. The test cases 402 are stored in a document store 310.

At step 206 the system 201 is supplied with features. Features are stored in a feature store 312. The features comprise statistical properties (for example, margin of error, estimated proportion of failure and confidence level). These statistical properties are used to calculate a sample size, for example, using Cochran's formula. Cochran's formula is a statistical method used to calculate an ideal sample size for a study. Alternatively other formulae could be used, such as Yamane, Rao etc.

For example, let the number of test cases 402 be 10, and the sample size, using Cochran, is determined by the system 201 as 2000. Therefore, 200× modified test cases 504, 508, 512 will later be generated from each of the ten test cases 402 to provide a sample size of 2000.

As part of the feature set a complexity level can be set by a complexity generator 308.

For example, the complexity level can be set at a figure that goes from 1 to 100 for each modality, where 1 represents a tiny change of complexity level, of 50 is a medium change and 100 is the highest complexity level. The skilled person would understand that other measures of complexity are possible. For texts, the lowest complexity level could mean that only a few words in a text, which aren't features are replaced with for example synonyms or a generalization. The highest complexity level could means that words in all features and many non-features are modified to have spelling mistakes, use a different form of expression (e.g. informal, angry, stressed, vague etc.) and comments might even be added.

Similarly, for other modalities, for example images, the lowest complexity level could mean that there's a slight modification of the contrast, while the highest complexity level could mean that all features are partially hidden and the scenery in the rest of the image has been modified using generative AI, for example by removing certain objects from the image. If the user makes a new iteration, complexity increases or stays constant. The system allows the complexity level to rise linearly, non-linearly or to be constant.

What constitutes a complexity level is fine tuned for each operation. Each operation modifies more of the content the higher complexity. And as complexity rises, more operations are applied. So, for example on complexity level of 100 it could have applied 10 operations on an image and each operation modifies quite a lot of the image. While on complexity level of 10 only one operation is applied on the image and it affects only a small portion of it. So complexity determines how much of the content is changed and the amount of operations that are applied to it.

Thus, the system maps what is regarded as a small complexity level in one modality with what would be regarded as a low complexity level in another modality etc. The system can then compare different modalities to see if one modality is more vulnerable than another.

Complexity variation may be made by the complexity generator 308 according to a defined complexity profile 602. The features may also comprise a parameter which defines which type of modifications the system is allowed to perform.

An example of settings for different modes is:

TABLE 1
Mode settings

| MODE | ALLOWED SETTINGS |
|---|---|
| PROMPTS | Alternative Codings |
| TEXTS | Alternative Codings |
| AUDIO | Alternative Codings; Alternative Bit Depths; Alternative |
| | Bit Rates; Alternative Number Of Channels; Dropouts; Any |
| | Location. |
| IMAGES | Alternative Image Formats;, Alternative Image Modes; |
| | Alternative Resolutions; Alternative Color Depths; Change |
| | Of Scenery; General Objects. |

At step 208 the system 201 is supplied with settings for a set of iterations. The settings are stored in a session store 314.

At step 210 a complexity profile 602 is established. The complexity profile 602 can also be displayed in a user interface. FIG. 6 depicts two complexity profiles 602-1, 602-2. Although the complexity profiles 602 are shown as lines, due to the nature of the iterations, the complexity profiles 602 represent discrete functions. For example, the complexity profile 602 could be established to increase linearly 602-1, or exponentially 602-2. The complexity profile 602 can demonstrate a number of characteristics, such as, but not limited to the complexity:
increasing fast for each iteration of challenges.
increasing uniformly for each iteration of challenges 602-1.
increasing slowly for each iteration of challenges 602-2.
constant for each iteration of challenges.

The skilled person will understand that many complexity profiles 602 may defined. For example randomly up and down (e.g. noise) or a rising square wave, or a triangle or sawtooth etc. The user can also choose a start complexity 604 for the first round of challenges. FIG. 6 depicts, for example, a start complexity 604 of ‘48’ out of a maximum of ‘100’. The user may also set the number of iterations I1:I5 from the start complexity 604 to the maximum. So for example, with a start complexity 604 of ‘48’, a linear complexity profile 602-1, five iterations gives successive complexities as ‘48’, ‘61’, ‘74’, ‘87’, and ‘100’. Whereas a slowly increasing complexity profile 602-2, five iterations gives successive complexities as ‘48’, ‘53’, ‘58’, ‘74’ and ‘100’. The number of iterations I1:I5 determine the resolution, as calculated by a granularity divider 306, how much granularity you will have depends on how many iterations are chosen. The complexity profile will then be split into that many discrete steps.

At step 211, the set of multimodal test cases 402 are provided to a modality detector 304. Since the set of multimodal test cases 402 may be multimodal, the modality detector 304 assigns a modality to each data item before passing the set of multimodal test cases 402 to the case generator 318. Different modalities have different methods for generating the cases, for example a generated case for a prompt is totally different from a generated case for an image. Therefore, the modality property store 316 contains a set of operations that applies to each specific modality. Examples of properties for texts include: misspellings, informal writing style, mood, elaboration, vagueness, excitement etc. Examples of properties for audio: signal to noise ratio, clicks, pops, encoding etc. Examples of properties for images can be features that are partially hidden, change of scenery, environmental conditions etc. Possible modifications for these objects are identified taking by computing a granularity of changes, complexity levels, use case settings (for example if certain types of operations should be used or not).

At step 211 the case generator 318 uses generative AI, using content from the document store 310, feature store 312, session store 314, and modality store 316 to generate alternative versions of each of the test cases 402. Therefore, 200× modified test cases 504, 508, 512 are generated from each of the 10× test cases 402 to provide a sample size of 2000. The case generator 318 comprises a set of subcomponents 320, one for each modality. Thus, for each modality, provided by the modality detector 304, the case generator 318 invokes a module that operates on that specific modality.

Properties from the modality store 316 can be extended through submission and maintenance of the modality store 316. In addition, the system uses rules provided by a user concerning which modifications the system is allowed to do.

The case generator 318 uses generative AI. For text, the generative AI may be an LLM.

Generative AI modifies test cases in several ways:
Automated test case generation: analysis of existing data, code, and user interactions to create diverse and thorough test cases, including edge cases and varied scenarios
Continuous updating: as software evolves, generative AI constantly updates and generates new test cases, ensuring test suites remain relevant
Test case optimization: AI models can identify and prioritize the most critical test cases, improving test coverage efficiency
Adaptation to code changes: generative AI can automatically select and create regression tests based on recent code modifications, focusing on potentially impacted areas
Enhancement of existing test cases: AI can augment existing test cases with additional details, such as steps and expected results, making them more comprehensive
Learning from historical data: the AI model learns patterns and relationships from existing test case data, using this knowledge to generate new, similar test cases.

Images may be modified using, for example, (but not limited to) a foundation model by removing and replacing objects on an image. A foundation model in generative AI is a large-scale, pre-trained machine learning model that serves as a versatile base for a wide variety of AI applications. These models are trained on massive datasets to learn patterns and relationships. Examples include DALL-E, Claude and Stable Diffusion. Audio may be modified using generative AI as well, for example (but not limited to) using autoregressive models, diffusion models or token-based representation.

The skilled person would understand that many types of generative AI could be used for case generation.

The case generator 318 has one subcomponent for each modality. Thus, for each modality, provided by the modality detector, the case generator 318 invokes a subcomponent 320 that operates on that specific modality. As an example, an image subcomponent 320 of the case generator 318 operates on images.

At step 212, a shape (mesh) is selected from the AI asset store 326 which comprises a pattern of blocks (alternatively circles or other shapes). The image subcomponent 320 calculates which shape (feature) to choose from the AI asset store 326 with respect to the current complexity level and previous iterations. Higher complexity will have denser and bigger blocks. The position of the mesh is adjusted with a random vertical and horizontal offsets.

The image subcomponent 320 checks the complexity level, and for each feature it calculates how big area of the feature that corresponds to, from zero to a maximum percentage which is lower than 100. In practice, maximum percentage will be around 50-60%. However, the maximum can be configured in the system, because it is applicable to which type of object that is going to be recognized. Certain objects which are based around the shape rather than text within have a lower recognition threshold. Similarly, objects which contain many details inside its outlining, can stand a much higher threshold and should still be possible to recognize.

As an example, the image subcomponent 320 picks in a round-robin fashion (for each generated case), a shape that is going to be used. These are pre-defined features which are obtained from the feature store 312, and can be used for masking of other objects in the test case 402. The round-robin selection ensures that all pre-defined shapes (features) in the feature store 312 are used.

The shape is imposed over the outlined section by putting it in the center of the outlined section and then moving it outwards in a random direction until the number of pixels it covers has reached the current complexity. If that fails, a new random position is chosen. If that fails, then a new shape is chosen. Until the exact position for the shape (mask) has been found. Thus, in a first alternative 504, a first shape 506 may be chosen.

The image subcomponent 320 paints over the area that is covered by the shape and uses an off-the-shelf generative AI function for repainting the area that is covered by the shape, on the source document which is used to create an AI generated case of that same document. The produced alternative test case 402, 504, 508, 512 is given a unique identification number (ID) and is stored in the AI asset store 326 together with the complexity settings that were an essential part of creating the image. A similar approach may be made to distort the 3D object 408.

Modification therefore can include distortions to objects in the test case, additions of objects, and deletion of objects etc.

At steps 214 and 216, distortions etc. are made to text and sound, respectively. At step 217 modifications are made to objects of additional modalities. For example, prompts are treated as having a unique modality, or other types of binary data such as time-discrete technical data or sensor data.

At each iteration I1:I5, 200× modified test cases 504, 508, 512, each with a corresponding complexity level, are generated from each of the 10× test cases 402 to provide a sample size of 2000. As each test case 402 is multimodal, corresponding modifications at the corresponding complexity level of made for each of the modes. FIG. 7 depicts a graph with two planes 702, 704. This graph 700 has three axes {Text, Image, Audio} for three modes. The skilled person would understand that >three modes are possible. A first plane 702 represents a first iteration I1, with complexity level of C1. A second plane 704 represents a second iteration I2, with complexity level of C2. Each point 706, 708, on each plane 702, 704 represents an alternative test 504, 508, 512 that has a common complexity for the corresponding iteration. The first plane 702 has text complexity level of C1, image complexity level of C1, and audio complexity level of C1. The second plane 704 has text complexity level of C2, image complexity level of C2, and audio complexity level of C2. In any iteration I1:I5, the same complexity level is used for each mode, so that the modes can be compared how they cope with the same complexity level.

A complexity level for a particular mode can be generated in a number of ways. For example, a complexity level of 48 for image mode may be created by changing the image into greyscale, or blanking out a portion of the image. On higher complexity levels there are more operations applied, and a bigger context is used to apply the operations. For example, on text a certain percentage of the text is modified and that percentage increases as the complexity rises. In addition, the text is modified in multiple ways (multiple operations).

The method iterates 218 until a maximum complexity level has been reached. The system 201 iterates with an increasing complexity level in each iteration, carrying out multimodal and multi-level testing of ordinary test cases 402 with or without features as provided by the user, to identify on which complexity level and in which modalities there might be challenges which could impose problems for the organization. As iterations of tests are carried out, the complexity generator 308 increases the complexity level as specified by the complexity profile 602.

To ensure that all complexity levels are included in all iterations, the complexity generator 308 uses a filtered tail 802, which provides a window function to ensure that although a move has been taken to a new complexity level, cases from previous iterations are included. The tail 802 is depicted in FIG. 8, which depicts the discrete difference equation. In FIG. 8, I1:I5 804 represents iterations and each circle 806 is a weight for the number of generated cases that will be included in the final output set.

The tail 802 can be adjusted internally in the system 201. For example, the tail 802 may only include the complexity level I5 from the last iteration, or the tail 802 may have a longer lookback to provide all prior complexity levels I1:I5. The ratio between new and old complexities (the weights) can also be adjusted internally.

This windowing function of prior complexities fills an important function: If there are any problems at a certain complexity level, they should have been fixed in the next. If they're not, then it will be revealed in the sense that they are still noticeable in the higher complexity levels because they were included.

The use of a tail brings in complexity levels from previous iterations as well. For example, in the second iteration I2, a certain portion of the tests (for example, 1600 tests) has complexity level of 61, and another portion of the tests (for example, 400 tests) have complexity level of 48.

Combinatorial effects are also considered. The higher the complexity level, the greater the number of combinations of different types of operations that are used, including inserting more occurrences of each operation into the data. For example, at the lowest complexity level, there might be only one slight operation on the data, such occurring at only one place in the data. However, on higher complexity levels (for example, above a complexity level of 50), there may be multiple combinations of operations occurring on many places in the data. As a further example, with a text mode, if two operations are applied, they could be synonyms and spelling mistakes. The system will then replace certain words with synonyms which have been misspelled.

The complexity generator 308 also takes modalities into account. For example with each data modality, it might not make sense to modify the data in a certain way. The complexity generator 308 then applies particular rules based on user settings for each modality. For example, a free-text survey analyzer always uses texts in UTF-8 format, so there's no sense working with different encodings. An online form only uses trouble shooting images in .PNG and .JPG format, so the complexity generator 308 only works on those formats. A speech-to-text engine always provides audio recordings that come from an indoor call-center, so the complexity generator 308 only adds background noise that simulates such an environment in different ways, but without adding any outdoor noise.

The complexity level is increased at a certain granularity, determined by the granularity divider 306. The system 201 iterates to create a set of images which constitutes a sequence of increasing complexity level, where each iteration makes an incremental change of the image, with or without using outlined features, using either a mesh which is used as a mask on the image by the generative AI that fills in missing regions in the mask, or by adding a mask onto the features of the image, according to the current complexity level, each mask appearing on different places in each iteration, possibly altering its shape in each iteration. Thus the new iteration I1:I5 can be set up.

For example, in first iteration I1 with complexity C1, a first alternative 504 is depicted with a first shape 506 obscuring a view of the bends in the mountain pass 412, a distortion to the 3D object, and an alteration of the sound output 406. In a second iteration I2 with complexity C2, a second alternative 508 is also depicted with a larger second shape 510 obscuring a view of the bends in the mountain pass 412 and the text content of the sign post 404, the distortion to the 3D object, and the alteration of the sound output 406. In a third iteration I3 with complexity C3, a third alternative 512 is also depicted as obscuring the text content of the sign post 404, a distortion and movement to the 3D object, an altering of the road sign 410 and muting of the sound output 406. In other words, the alternative versions of the test cases provide alternatives to test case content of all determined modalities.

The test cases 402, and corresponding alternative test cases 504, 508, 512 act as challenges to the external AI system 302.

The AI asset store 326 now contains a set of AI generated images, which were generated with an increasing complexity level, where the user has determined how much the complexity should increase in each step.

At step 220 a router 324 sends a challenge to the external AI system 302, along with the source from which the test case was constructed, to the external AI system 302. At step 222 the external AI system 302 runs tests on the challenge. At step 224 the external AI system 302 responds back over the API 328 including the IDs of the associated items in the set of multimodal test cases 402 and the result. Since the challenge was generated from the set of multimodal test cases 402 and an analyser 322 comprises a ground truth for the set of multimodal test cases 402, at step 226 the analyser 322 can trace which properties and combinations of properties may be causing problems for the external AI system 302. The ground truth acts as a baseline The analyser 322 uses a distance function to measure the outcome of both to determine whether the outcome should be regarded as the same or not. In machine learning the distance function gives the distance between elements of a set. A distance of zero indicates the elements are equivalent. Methods like classification, clustering, and retrieval require distance functions to define distances. The skilled person would understand that other measures of closeness or correctness could be used.

The system 201 takes one test case 402 and creates the set of modified alternative versions 504, 508, 512. Each alternative 504, 508, 512 is compared with the original test case 402 using a distance function which can be selected by the user, or defined by the user. The distance function takes the original test case 402 and the alternative 504, 508, 512 and compares them to see if they are within a distance of being regarded as equal. The distance function can be a foundation model or just a simple text equality comparison, depending on what the external AI system 302. There's only one distance function that is used. The user can select among a plurality of distance functions to use though, but once selected then it's only one.

Distance function is used to measure how close the result of the challenge is to the result of the original data challenge. Original data is challenging the external AI system 302 and provides a result which is the expected result (because it's the original data supplied by the user). A variation is crafted and sent to the external AI system 302. The result of the alternative is supposed to provide the same response (within a certain distance).

Thus the analyser 322 determines whether the result of the external AI system 302 responding to the challenge meets requirements of the external AI system 302, and if not, which properties and combinations of properties may be causing problems for the external AI system 302. For example, in FIGS. 5 and 6, the requirement is to identify a correct route. If the addition of first shape 506 in the first alternative 504 caused the external AI system 302 to identify the correct route, but the addition of second shape 510 in the second alternative 508 caused the external AI system 302 to misidentify the correct route, the analyser may conclude that the difference between the first shape 506 and the second shape 510 caused a problem.

The analyser 322 traces these properties, and combinations. For example, the analyser 322 checks if there are reoccurring property types and make a frequency table of these. The analyser 322 may also use more advanced methods as well, such as clustering, to identify combinatorial weaknesses.

The modification operations are saved in persistent storage. Since different combinations of operations are used for each new content that is created, it becomes possible to find out (through clustering and frequency tables) if certain operations often cause fail or certain combinations often cause fail. For example, you have one single document. The complexity generator creates 100 new documents from it. Each new document (of the 100) has a different set of operations applied to it (but on one and the same complexity level). Since only a subset of the 100 will cause a fail, not all, then it becomes possible to find out if certain combinations cause the fail or certain operations.

By testing the alternatives in the same order (by using their IDs, which can be sorted), the user can see when the external image detection algorithm cannot identify the object any longer. And then it will be possible to get statistics on how weak the detection algorithm is, or in other words, how much of an object that needs to be either not visible or modified before it fails to identify it.

The system 201 also uses methods to trace vulnerabilities within a particular modality. Thus, the system provides multi-level tracing of weaknesses in multimodal data (both on modality level and within a particular modality). Tracing can be made with respect to a particular complexity level which is either constant or can increase in different ways, configurable by the end user as the user iterates over challenges.

The system 201 sends information the alternative test case to the external AI system as a training set. The information comprises for example, results of the analysis to the external AI system 302, the alternative test case that caused the external AI system 302 to fail, the modality vulnerability traces, and the ground truth to the external AI system 302, so that the external AI system 302 can use the information. If the challenge resulted in the external AI system 302 not being able to provide an expected response (compared to the source test case 402 from which it was generated from), the challenge is a failed challenge, and as such the user might find it useful to use it later on for fine-tuning a foundation model or for retraining a machine learning model of the external AI system 302.

The system 201 stores the generated data in the AI asset store 326 and provides each item's ID over the API. If a new session is carried out on the same source set of test cases 402, the system 201 can provide an even richer set of generated cases by building on what has already been generated in previous sessions. This is then carried out by offsetting the granularity boundaries of the generated dataset, and by using properties and property combinations which haven't been used before.

At step 228, the analyser 322 reports results of the analysis.

At step 299 the method ends.

In alternative embodiment, at step 266 the system 201 identifies that a particular iteration I2:I5 has a problem, but the previous iteration I1:I4 does not. The system 201 performs a midpoint method or binary search, starting at the midpoint between the iteration and the previous iteration. This method is particularly efficient because it halves the search space with each iteration, allowing quick converge on the desired number. The skilled person would understand that other search techniques are possible to identify an accurate failing complexity number.

In an alternative embodiment, the system 201 runs clustering (affinitive propagation in the prototype) on the test results which were provided and presents the result for the user who can see if certain combinations of properties are problematic. Besides the combinatorial analysis, the system creates a frequency table of which single properties that are causing most problems and on which complexity level they do so. The system also calculates the ratio of features causing problems and non-feature related modifications which create wrong results. The ratio is also displayed for the user who can see if there are general problems with the external text analysis (not necessarily the features) or if it's sensitive to modifications of the features themselves (if any).

In an alternative embodiment, the external AI system 302 downloads all the generated cases and a description of which ones that failed from the system 201, so the external AI system 302 can be retrained or fine-tuned on these cases to improve it.

The invention has been described using an example of a multimodal test case of route finding. In an alternative embodiment, a set of test cases are provided in text form, and the system 201 interprets the text to form an initial set of test cases. In the above example, the abstract text may read “the external AI system performs route planning using multimodal data”, or “the external AI system performs route planning using data including desert scenes, road signs, sign posts and audio”. The system 201 could interpret such text with an LLM.

Other examples are:
for text, the external AI system 302 analyses free-text survey responses where users have opinions about a product;
for prompts, the external AI system 302 retrieves information from a database to answer technical questions which are asked by users;
for images, the external AI system 302 checks quality on agriculture food, for example, potatoes and responds ‘OK’ or ‘NOT OK’;
for audio the external AI system 302 uses a foundation model to transcribe recorded audio into text.

Another example to illustrate the invention is a company that has recorded 10 audio clips of a call-center response with 10 customers. These recordings are transcribed by the external AI system 302. The transcription is verified as correct and therefore are good representatives for what they are doing. These 10 recordings are provided to the system 201 as the set of test cases 402.

The system 201 creates 20 new modified recordings for each of the 10, thus ending up with 200 new recordings (a total of 211). These 211 are sent to the external AI system 302, which has been integrated with the system 201 and the result is measured, logged and analysed to see which types of modifications that make the external AI system 302 fail to transcribe the text correctly.

1. A computer implemented method for enhancing an external artificial intelligence, AI, system, the method comprising:
receiving at least one test case, the at least one test case comprising a set of objects;
providing, using a generative AI model, a set of modifications to the at least one test case to generate a set of alternative test cases, each of the set of modifications comprising a respective complexity level;
challenging the external AI with the set of alternative test cases to determine a result from running the set of alternative test cases on the external AI system; and
comparing the respective result with a baseline to determine if the respective complexity level causes a problem in the external AI system.

2. The method of claim 1, wherein the set of objects comprises a set of multimodal objects, the method further comprising:
identifying one or more modalities of each of the objects, wherein providing comprises, for at least one of the objects, for each of the identified modalities, using a respective generative AI model for modifying at least one object of the respective modality; and
fusing the set of modified objects to provide the at least one alternative test case.

3. The method of claim 1, wherein providing a set of modifications is performed iteratively, each iteration comprising a respective complexity level.

4. The method of claim 3, wherein the respective complexity levels follow a complexity profile between iterations.

5. The method of claim 4, wherein the complexity profile is taken from a group, the group comprising at least the complexity profile: increasing fast for each iteration; increasing uniformly for each iteration; increasing slowly for each iteration; constant for each iteration; randomly up and down; a rising square wave; a triangle; and a sawtooth.

6. The method of claim 1, wherein the set of alternative test cases comprises a first portion comprising a first set of alternative tests cases from a first iteration, and a second weighted portion comprising a second set of alternative test cases from a second iteration.

7. The method of claim 4, wherein a number of iterations is determined for complexity levels between a start complexity level and a maximum complexity level.

8. The method of claim 1, wherein the at least one test case comprises one of a list, the list comprising: an image; audio; text; a prompt, and binary data, and wherein generating comprises selecting a feature, modifying the feature, and adding the modified feature to the at least one test case to provide the at least one alternative test case.

9. The method of claim 1, further comprising:
in response to determining a problem in the external AI system, sending information about the set of alternative test cases to the external AI system.

10. The method of claim 1, wherein a parameter defines which type of modifications the system is allowed to perform.

11. The method of claim 1, further comprising receiving a user defined distance function, and wherein comparing the respective result comprises using the distance function.

12. A system for enhancing an external artificial intelligence, AI, system, the system comprising: a memory;
at least one processor in communication with memory; and program instructions executable by one or more processor via the memory to perform a method comprising:
receiving at least one test case, the at least one test case comprising a set of objects;
providing, using a generative AI model, a set of modifications to the at least one test case to generate a set of alternative test cases, each of the set of modifications comprising a respective complexity level;
challenging the external AI with the set of alternative test cases to determine a result from running the set of alternative test cases on the external AI system; and
comparing the respective result with a baseline to determine if the respective complexity level causes a problem in the external AI system.

13. The system of claim 12, wherein the set of objects comprises a set of multimodal objects, the method further comprising:
identifying one or more modalities of each of the objects, wherein providing comprises, for at least one of the objects, for each of the identified modalities, using a respective generative AI model for modifying at least one object of the respective modality; and
fusing the set of modified objects to provide the at least one alternative test case.

14. The system of claim 12, wherein providing a set of modifications is performed iteratively, each iteration comprising a respective complexity level.

15. The system of claim 14, wherein the respective complexity levels follow a complexity profile between iterations.

16. The system of claim 15, wherein the complexity profile is taken from a group, the group comprising at least the complexity profile: increasing fast for each iteration; increasing uniformly for each iteration; increasing slowly for each iteration; constant for each iteration; randomly up and down; a rising square wave; a triangle; and a sawtooth.

17. The system of claim 12, wherein the set of alternative test cases comprises a first portion comprising a first set of alternative tests cases from a first iteration, and a second weighted portion comprising a second set of alternative test cases from a second iteration.

18. The system of claim 12, wherein a number of iterations is determined for complexity levels between a start complexity level and a maximum complexity level.

19. The system of claim 12, wherein the at least one test case comprises one of a list, the list comprising: an image; audio; text; a prompt, and binary data, and wherein generating comprises selecting a feature, modifying the feature, and adding the modified feature to the at least one test case to provide the at least one alternative test case.

20. A computer program product for enhancing an external artificial intelligence, AI, system, the computer program product comprising a computer readable storage medium having program instructions embodied therewith, the program instructions executable by a processor to cause the processor to perform a method comprising:
receiving at least one test case, the at least one test case comprising a set of objects;
providing, using a generative AI model, a set of modifications to the at least one test case to generate a set of alternative test cases, each of the set of modifications comprising a respective complexity level;
challenging the external AI with the set of alternative test cases to determine a result from running the set of alternative test cases on the external AI system; and
comparing the respective result with a baseline to determine if the respective complexity level causes a problem in the external AI system.
